(19) United States
(12) Patent Application Publication
(10) Pub. No.: US 2005/0007070 A1
(43) Pub. Date: Jan. 13, 2005

(54) Personal power recharging organizer

(76) Inventors: Jonathon Ryan Webb, Oklahoma City, OK (US); Angela Arleen Wallen, Oklahoma City, OK (US)

Correspondence Address: Jonathon R. Webb, 2715 NW 17th, Oklahoma City, OK, 73107, US

(21) Appl. No.: 10/853,813

(22) Filed: May 26, 2004

Related U.S. Application Data
(60) Provisional application No. 60/473,864, filed on May 27, 2003.

(51) Int. Cl. H02J 7/00

(52) U.S. Cl. 320/113

(57) ABSTRACT

An organizing device for cell phones, PDAs, power tools, appliances or any other device that uses a plug-in power adapter to an a.c. power supply including a housing with a plurality of adjustable slots for holding and storing the cell phones, PDAs, power tools, appliances or other devices and a plurality of receptacles therein which are adapted to receive said devices' plug-in power adapters. The receptacles are exposed on one surface and the adjustable slots are exposed on a different surface on the same organizing device. The housing is provided with a plurality of electrical outlets and may or may not have a main lighted power switch all of which are disposed on the housing in accessible positions. A main electrical cord connects the electrical receptacles on the housing to a wall socket. The housing also has a plurality of adjustable slots and cut-outs which are designed to route the cables attached to the power adapters to the cell phones, PDAs, power tools, appliances or other devices in such a manner that they are somewhat hidden and out of the way. Accordingly, it is a principal object of the invention to provide cell phones, PDAs, power tools, appliances or any other devices an organizer that combines a plurality of terminal receptacles with a main power switch, a plurality of adjustable slots for receiving and holding the cell phones, PDAs, power tools, appliances or any other devices as they are being charged, an on/off lighted A/C power switch and a main power cord.

Applicant claims the benefit of earlier U.S. Provisional Patent Application Filing Date—May 27, 2003 Title—Personal Power Recharging Station Application No.—60/473,864

The present invention is an organizer device for cell phones, PDAs, power tools, appliances and similar types of devices that use plug-in power adapters to recharge their batteries. The housing is provided with a plurality of electrical outlets and a main lighted power switch all of which are disposed on the housing in accessible positions. A main electrical cord connects the electrical receptacles on the housing to a wall socket. The housing also has a plurality of adjustable slots and cut-outs which are designed to route the cables attached to the power adapters to the cell phones, PDAs, power tools, appliances or other devices in such a manner that they are somewhat hidden and/or out of the way.

It is a further object of the invention to provide an organizer that is available in a variety of decorative finishes intended to match the furnishings or fixtures within the area of intended use.

Still another object of the invention is to provide an “at-a-glance” view of the devices being held by the invention in order to determine that all necessary devices are in their place and are being charged.

It is an object of the invention to provide improved elements and arrangements thereof in an apparatus for the purposes described which is inexpensive, dependable and fully effective in accomplishing its intended purposes.

### BACKGROUND OF INVENTION

1. Field of the Invention

The present invention relates to cell phones, Personal Digital Assistants, power tools, appliances and other similar devices and more specifically to an organizer device useful in connection with various devices that use plug-in power adapters to an a.c. power supplies.

2. Description of Prior Art

The emergence of numerous electronic devices as common features of today's environment, whether the office, industry or the home, is well recognized. The general need to hold, store and organize these types of devices and simultaneously recharge their batteries is widely recognized.

No prior art devices show a combination of a plurality of terminal receptacles with a main power switch, a power cord, and a plurality of receptacles adapted to receive a plurality of cell phones, PDAs, power tools, appliances and other devices that use plug-in power adapters to a.c. power supplies.

The only prior art are U.S. Pat. Nos. 4,591,777 awarded May 27, 1986 and 4,739,242 awarded Apr. 19, 1988 for a Multistation modular charging system for cordless units. This system is considerable different from this invention, the Personal power recharging organizer because it is a charging system for specifically designed appliances and tools which have the same types of housing, electrical contacts and batteries which are designed specifically for the recharging station. Part of the prior art patent states that it uses “manufacturing standardization in the fabrication of the multistation modular charging system”. It makes no reference to using plug-in power adapters for the devices it recharges nor to the use of a mix of appliances or devices manufactured by many different companies and having different housing for each of the appliances or devices.

### BRIEF SUMMARY OF INVENTION

The present invention is an organizer device for cell phones, PDAs, power tools, appliances and similar types of devices that use plug-in power adapters to recharge their batteries. The housing is provided with a plurality of electrical outlets and a main lighted power switch all of which are disposed on the housing in accessible positions. A main electrical cord connects the electrical receptacles on the housing to a wall socket. The housing also has a plurality of adjustable slots and cut-outs which are designed to route the cables attached to the power adapters to the cell phones, PDAs, power tools, appliances or other devices in such a manner that they are somewhat hidden and/or out of the way.

It is a further object of the invention to provide an organizer that is available in a variety of decorative finishes intended to match the furnishings or fixtures within the area of intended use.

Still another object of the invention is to provide an “at-a-glance” view of the devices being held by the invention in order to determine that all necessary devices are in their place and are being charged.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following drawings.

### BRIEF DESCRIPTION OF THE DRAWINGS

FIG. 1 is an environmental perspective view of the personal power recharging organizer according to the present invention.

FIG. 2 is another environmental perspective view of the personal power recharging organizer according to the present invention.

FIG. 3 is yet another environmental perspective view of the personal power recharging organizer according to the present invention.

FIG. 4 is an environmental perspective view of the bottom of the personal power recharging organizer according to the present invention and displays the cleat type of cable organizers that could be used on the underneath side of the device.

FIG. 5 is another environmental perspective view of the bottom of the personal power recharging organizer according to the present invention and displays a post type of cable organizers that could be used on the underneath side of the device.

FIG. 6 is a front device panel plan view of the personal power recharging organizer according to the present invention.

FIG. 7 is a front electrical receptacle view of the personal power recharging organizer according to the present invention.

FIG. 8 is an end plan view of the personal power recharging organizer according to the present invention.

FIG. 9 is the other end plan view of the personal power recharging organizer according to the present invention.

FIG. 10 is the top plan view of the personal power recharging organizer according to the present invention.

FIG. 11 is the bottom plan view of the personal power recharging organizer according to the present invention.

FIG. 12 is the front plan view of the power bar side of the non-powered version of the personal power recharging organizer according to the present invention.

FIG. 13 is an end plan view of the non-powered personal power recharging organizer according to the present invention.

FIG. 14 is the other end plan view of the non-powered personal power recharging organizer according to the present invention.

FIG. 15 is the front plan view of the power bar side of the non-powered version of the personal power recharging organizer according to the present invention.

FIG. 16 is an end plan view of the non-powered personal power recharging organizer according to the present invention.

FIG. 17 is the other end plan view of the non-powered personal power recharging organizer according to the present invention.

FIG. 18 is a side, front and top view of a suggested separator panel which would be used to created receptacles for holding the various devices that could be organized and/or recharged by the personal power recharging organizer according to the present invention.

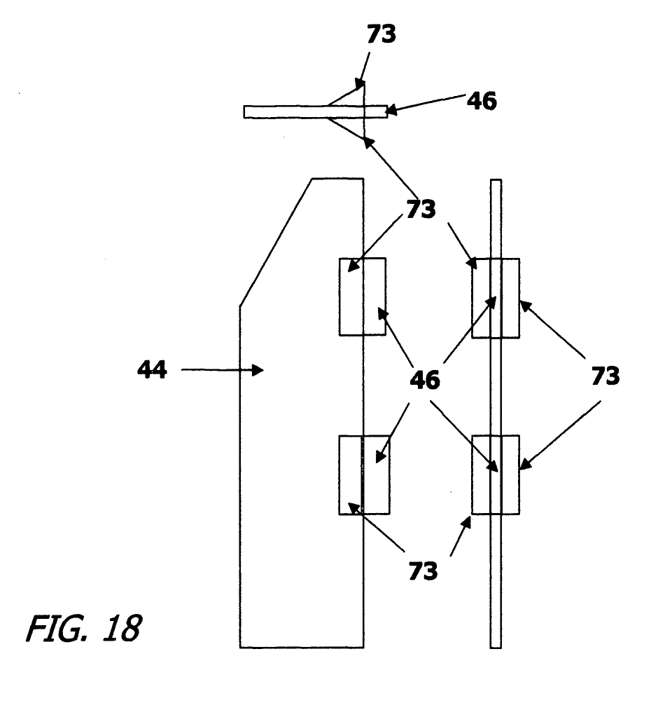

FIG. 19 are views of a typical plug-in power adapter and a typical power strip

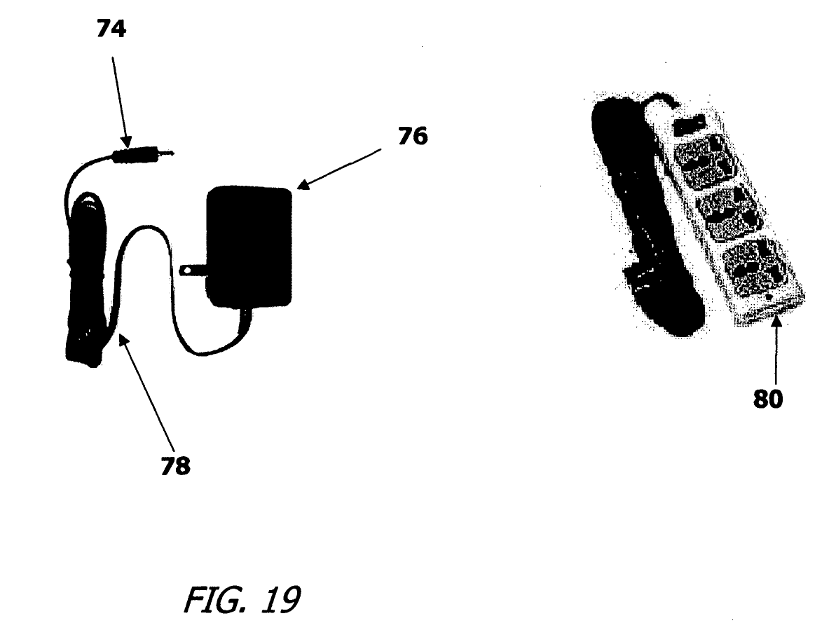

Similar reference characters denote corresponding features consistently throughout the attached drawings.

### DETAIL DESCRIPTION OF INVENTION IN PREFERRED EMBODIMENT REFERRING TO DRAWINGS

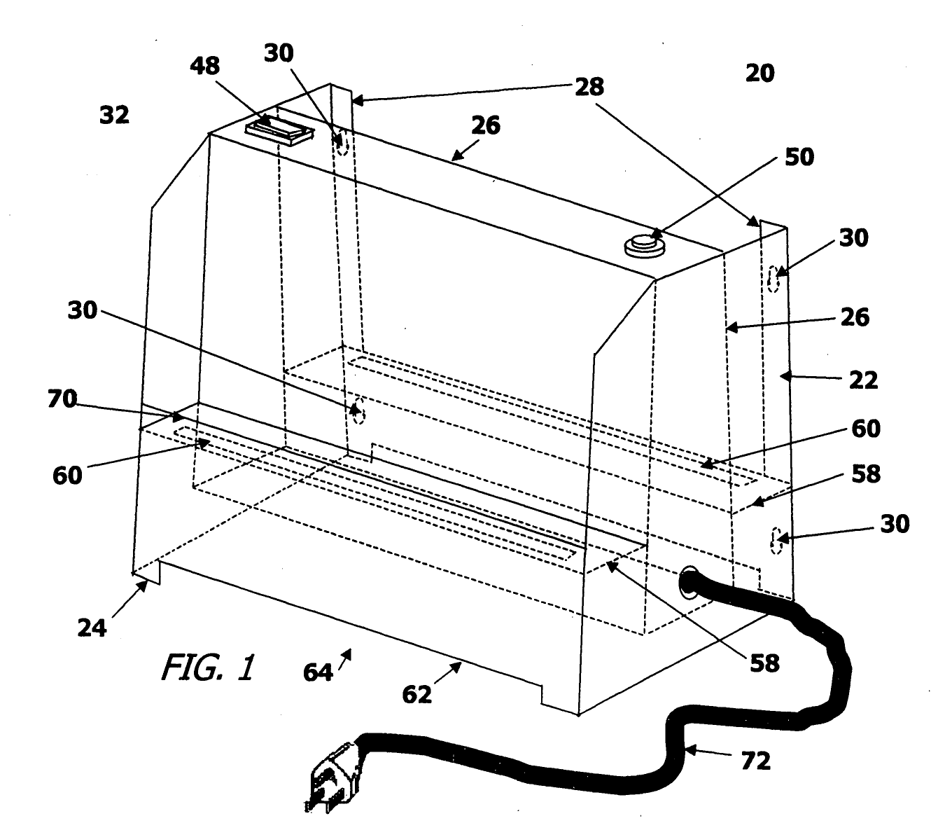

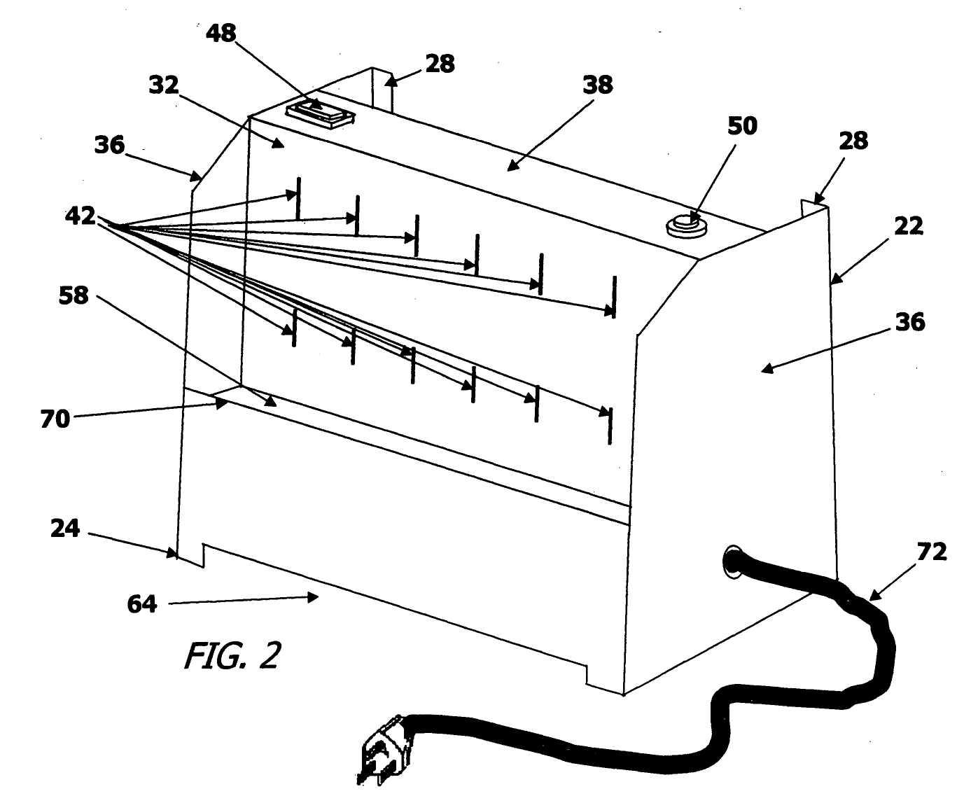

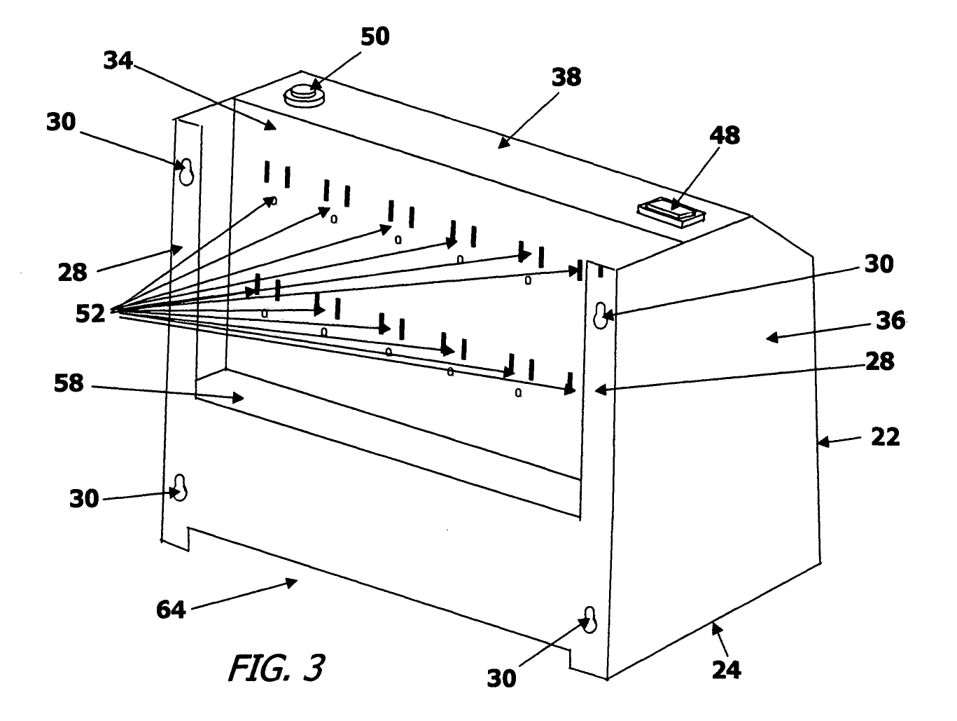

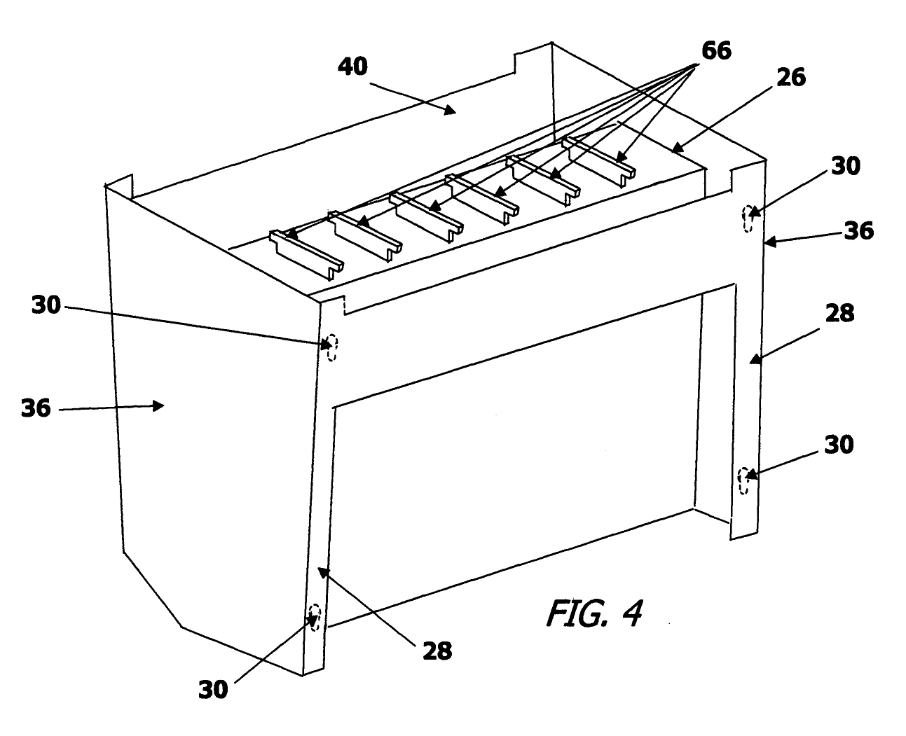

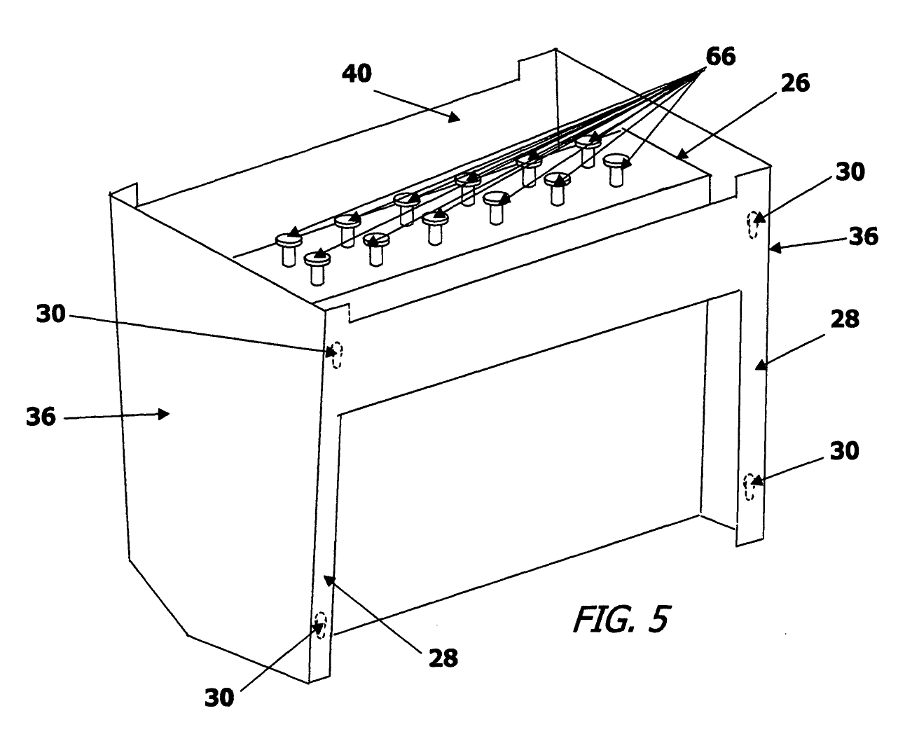

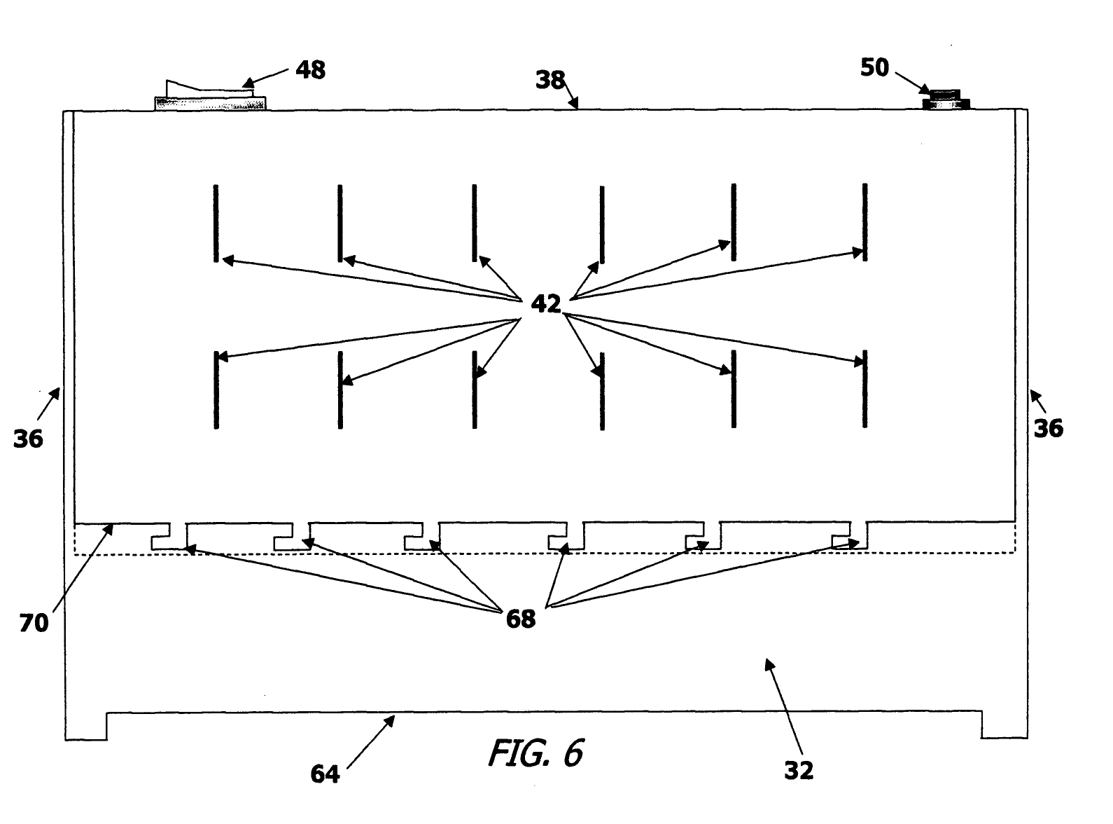

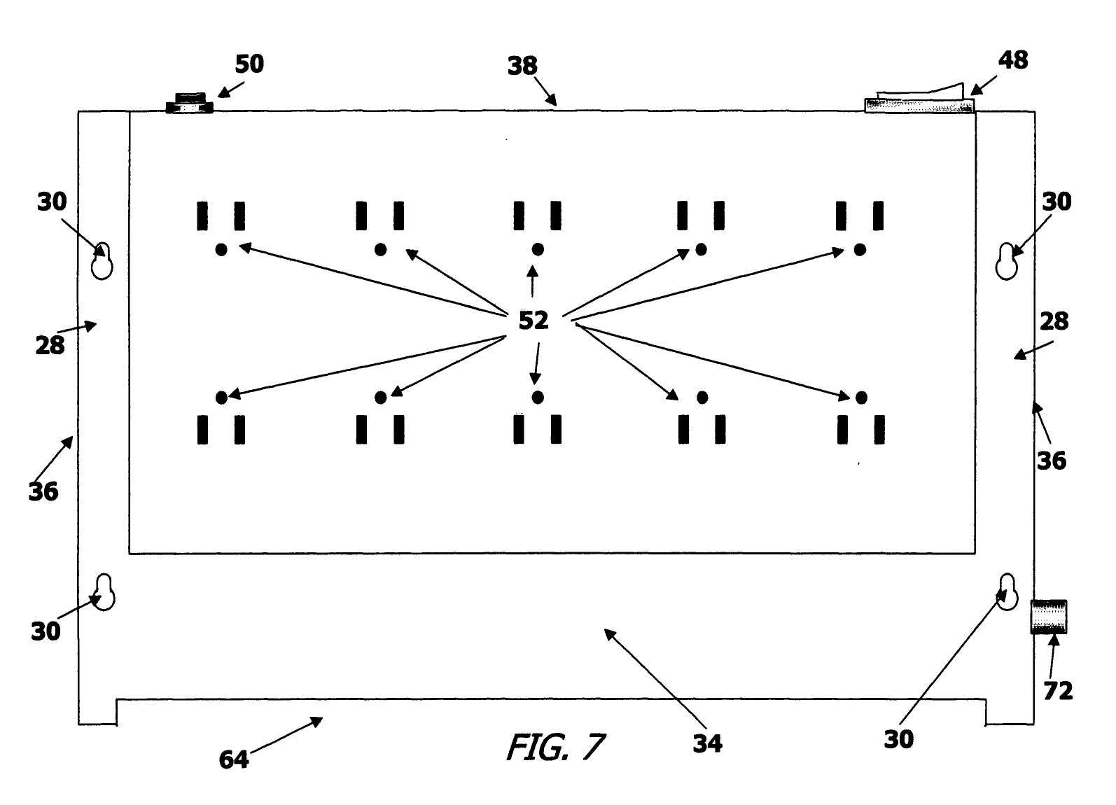

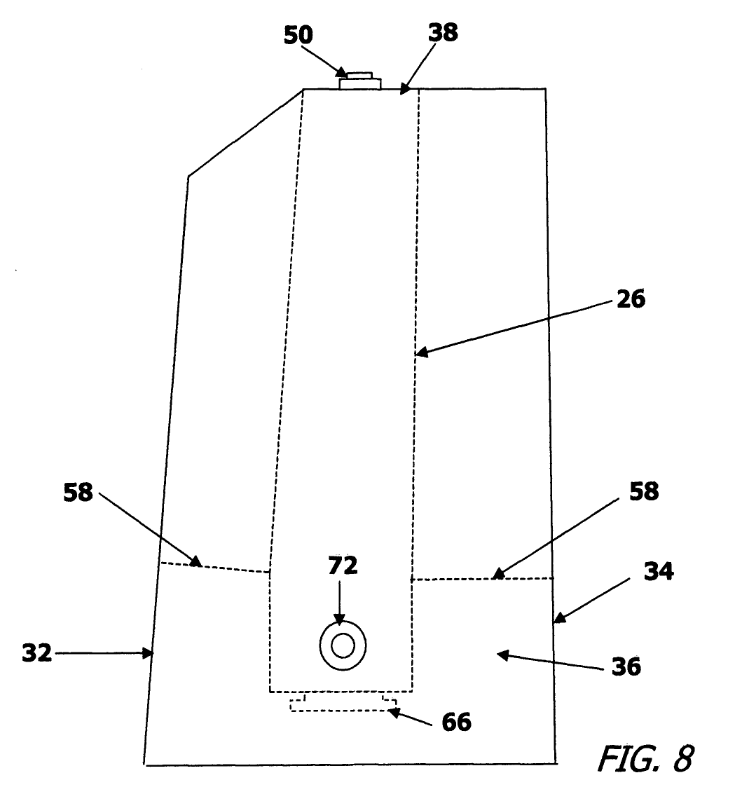

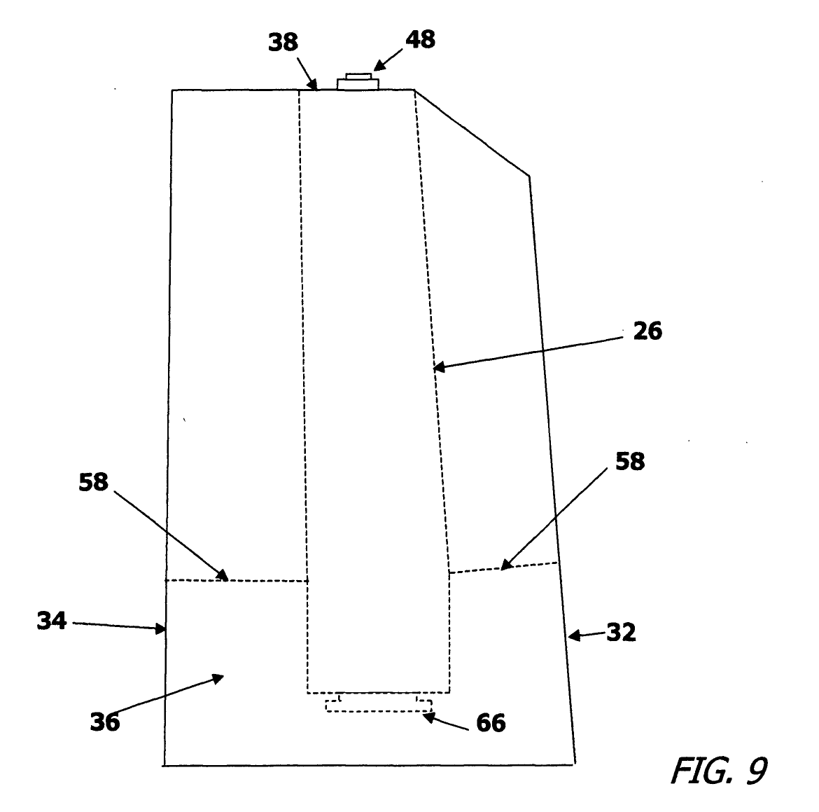

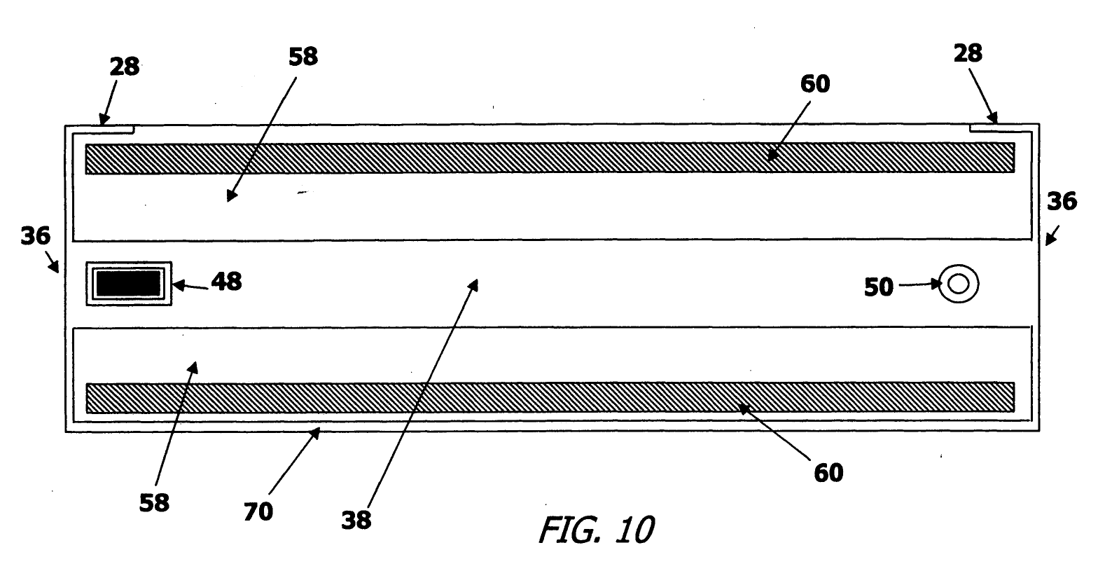

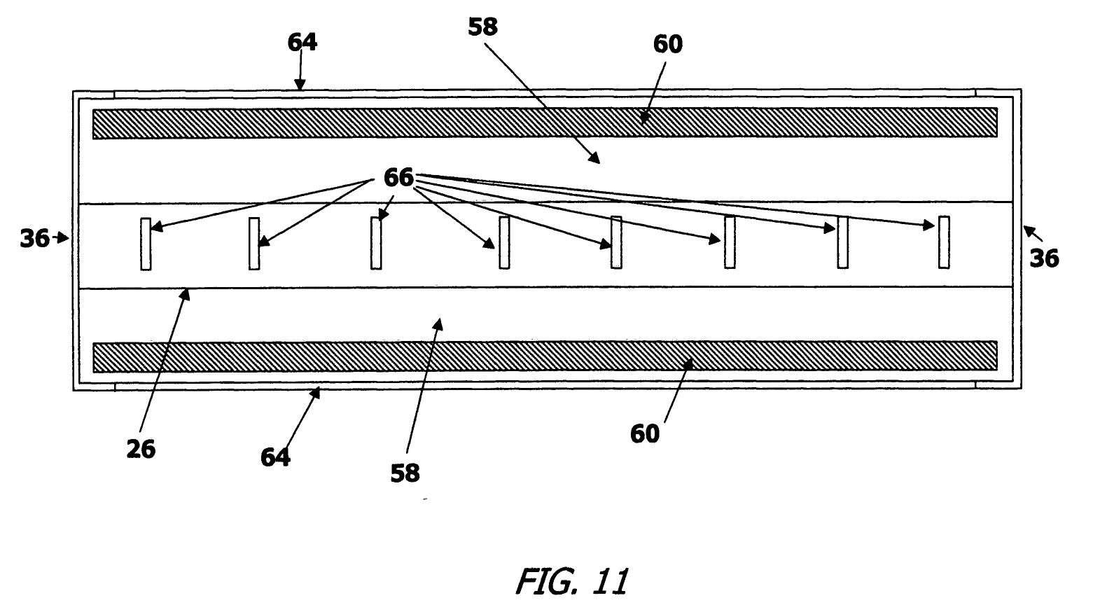

Referring to FIGS. 1-11, the present invention is an organizer device for cell phones, Personal Digital Assistants and other similar devices which may be adapted to be placed on a planar horizontal surface. The device 20 comprises a housing 22 which may have any shape or configuration. As shown in the accompanying figures, the housing 22 has a configuration which has a planar base 24 which lends itself to placement upon a horizontal surface (i.e., countertop, vanity, etc.) and it also has integral mounting holes 30 within the back mounting rails 28 for ease of mounting upon a wall.

The housing 22, with its box-like configuration, includes a substantially planar base 24 supporting a center section 26 which in turn provides a substantially planar front 32, a substantially planar back 34, end-walls 36, a top 38 and an open housing bottom 40. The front 32 is provided with a plurality of slots 42 for holding separator panels 44 which create adjustable sized openings which receive variously sized and shaped devices Each receptacle therefore is aligned in a substantially vertical orientation with an open top and front. In other embodiments these removable panels 44 could instead be static separator panels. However, it should be apparent to one skilled in the art that the receiving receptacle openings need not be limited to the top surface, but may also be exposed through any side of the housing 22 with the receptacles oriented in any substantially vertical or horizontal position. Although not shown, the receptacles may be exposed through the top or a sidewall with an angular alignment.

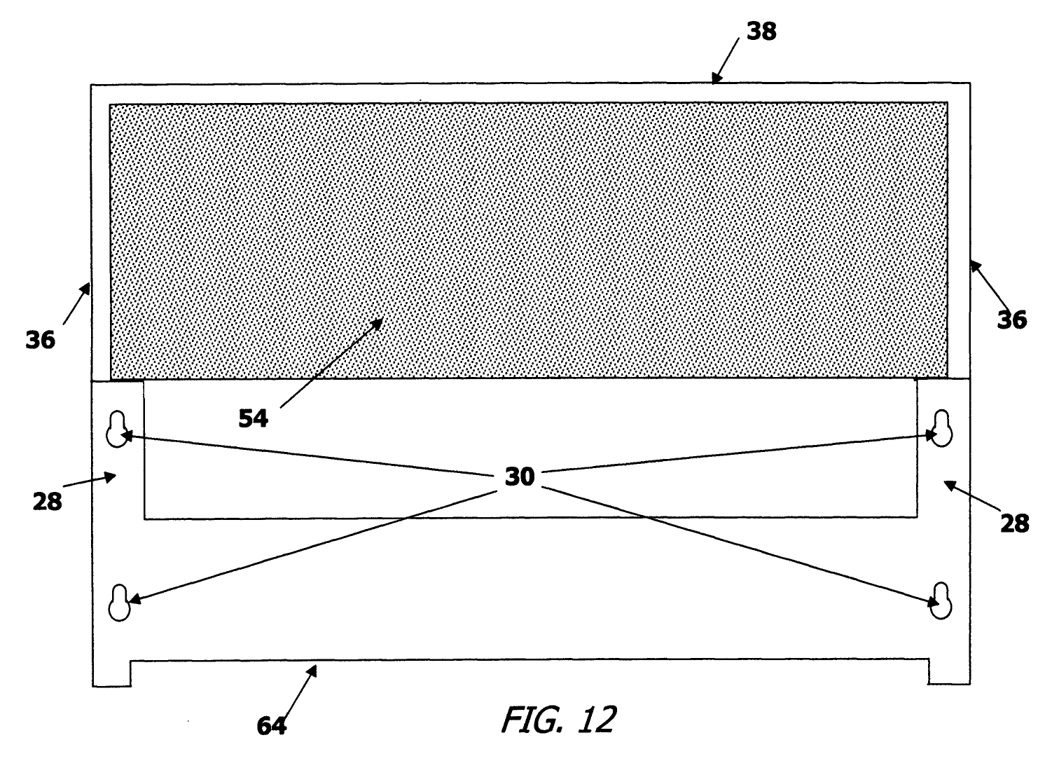

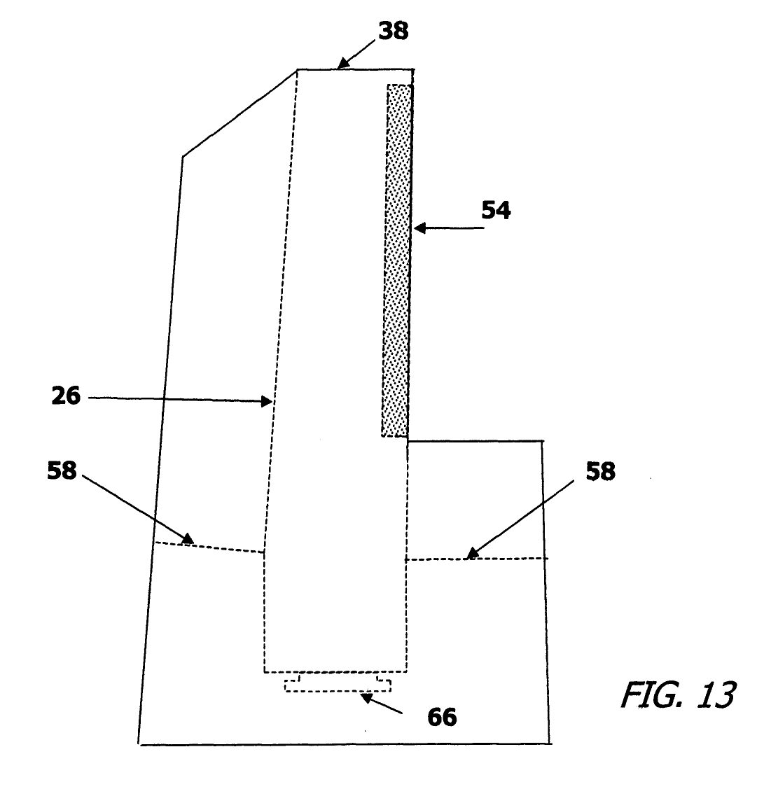

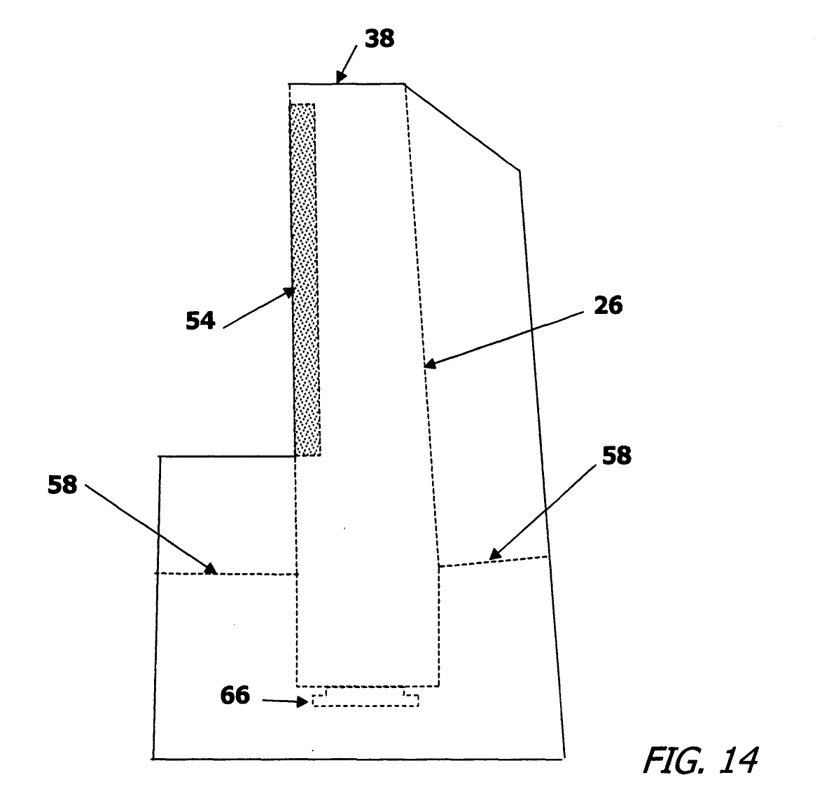

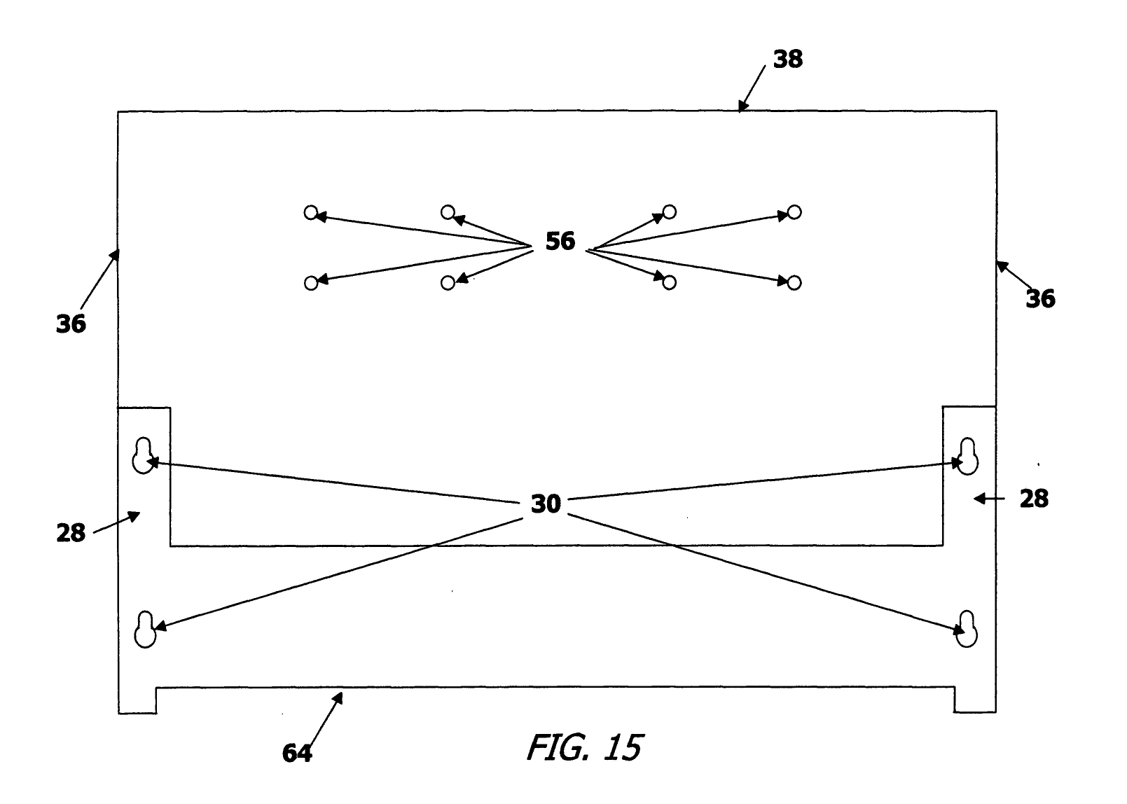

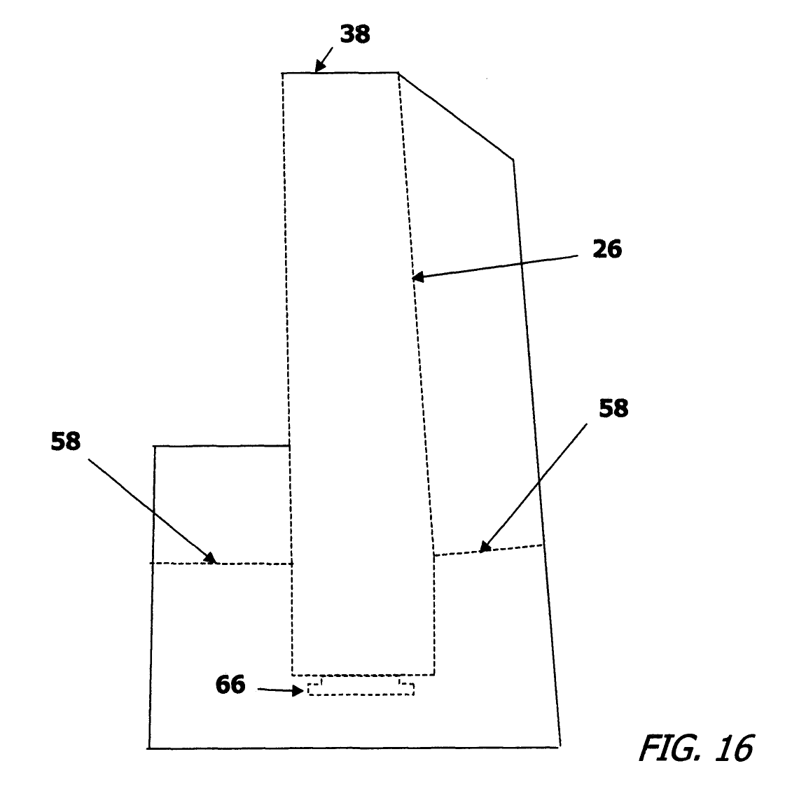

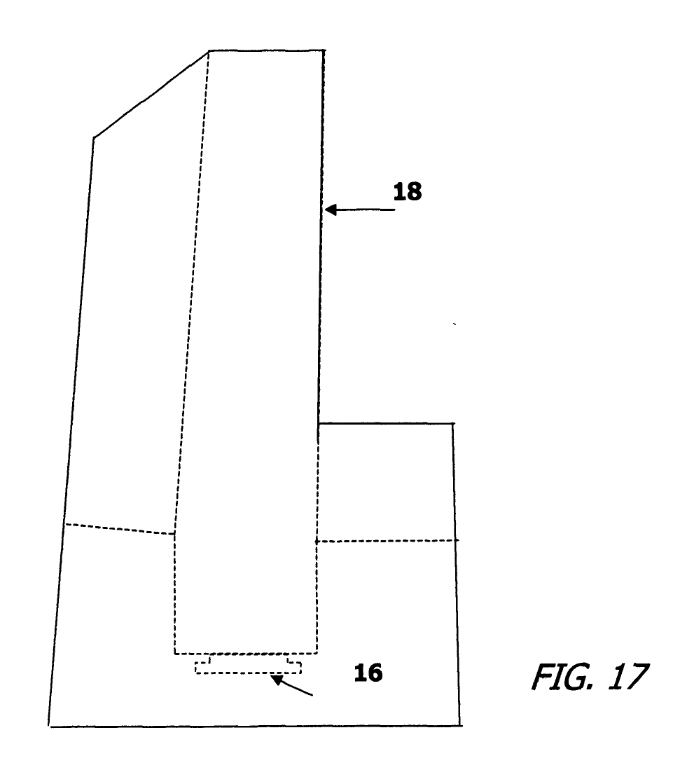

Each of the receptacles preferably is formed with a separator panel 44 that has tabs 46 or some other type of attachment(s) that can be fitted into the slots 42 or some other type of receiving accouterment on the front 32. On the top 38 is a main lighted power switch 48 and a circuit breaker button 50. On the back 34 is a plurality of electrical outlets 52 which are disposed to receive plug-in power adapters used by cell phones, PDAs, power tools, appliances and other devices to recharge their batteries. In the first embodiment of FIGS. 1- I 1, the electrical outlets 52 and surge protection circuitry are an integral part of the housing 22 and are shown. In FIGS. 12-14, some type of material 54 (such as wood) is made an integral part of the back of the housing 22 in order to allow for a conventional power strip to be attached to the housing 22 using mounting screws screwed into the material 18 which is attached to the housing 22 and can accept the mounting screws that usually come standard with a conventional power strip. In FIGS. 15-17, a plurality of screw mounting holes are built into the back panel of the housing to accept a predetermined type of power strip. In the embodiments shown in FIGS. 12-17, the housing would not need any electrical wiring or lighted power switch.

The device 20 may be removably mounted upon a wall with the use of conventional wall anchors and screw mounting holes 30 provided in the back 34, or any other conventional brackets, braces, or other mounting means. In the preferred embodiment, the device 20 is equipped with a standard main power cord 72.

There is a setback 58 on both the front and the back of the device 20. Each of the setbacks 58 has a cable guide slot 60 in the bottom of each setback 58.

On the bottom edge 62 of both the front and back of the housing base of the device 20 there is a cable routing cutout 64.

On the inside of the bottom of the housing base 40, there are a plurality of cable organizing devices 66 attached to the bottom of the center support section 26.

A plurality of cable holding notches 68 are cut into the top edge of the device railing 70.

In another embodiment, as shown in FIGS. 12-17, the device 20 will have no power cord or electrical switches.

It is to be understood that the present invention is not limited to the sole embodiment described above, but encompasses any and all embodiments within the scope of the following claims.

REFERENCE NUMBERS
20 device called Personal Power Recharging Organizer
22 device housing
24 housing base
26 Center supporting section
28 Mounting rails
30 Mounting holes
32 housing front
34 housing back
36 End walls
38 housing top
40 housing bottom
42 Slots for separator panels
44 Separator panels
46 Panel attachment tabs
48 Power switch
50 Circuit breaker reset button
52 Electric outlets
54 Material which can accept the attachment of screws
56 Screw mounting holes
58 setback
60 Cable guide slot
62 housing bottom edge
64 Cable routing cutout
66 Cable organizing devices
68 Cable holding notches
70 device railing
72 Electric power cord and plug
73 Strain support bracket
74 Powerjack
76 Plug-in power adapter
78 cable
80 Power strip

OPERATION

In the preferred embodiment of the Personal power recharging organizer the power cable 72 is plugged into an electrical outlet and the power switch 48 is switched to the on position. The separator panels 44 are attached to the housing front 32 in a way to provide each cell phone, PDA or other similar device the amount of receiving space needed to hold each device. The plug-in power adapter 76 for each cell phone, PDA, power tool, appliance or other similar device is plugged into the electrical outlets 52 on the back side 34 of the housing 22. The cable 78 for each cell phone, PDA, power tool, appliance or other similar device is then routed through either the cable guide slot 60 or the cable routing cutout 64 on the back 34 of the housing 22. This cable 78 is then run under the housing 22 towards the housing front 32. The cable 78 is then run up through the cable guide slot 60 on the housing front 32 or through the cable routing cutout 64. In this way the power jack 74 for the plug-in power adapter 76 is available to be plugged into the cell phone, PDA, power tool, appliance or other similar device. The power jack 74 is then plugged into the cell phone, PDA, power tool, appliance or other similar device and that device can then be placed into the receiving space on the housing front 32 and rested on the setback 58. The power jack 74 that extends from the cell phone, PDA, power tool, appliance or other similar device can extend down through the cable guide slot 60 thus preventing any pressure or strain to be placed on the power jack connector on the cell phone, PDA, power tool, appliance or other similar device. Any loose cable 78 can be wrapped around the cable organizing devices 66 found on the housing bottom 40.

When the cell phone, PDA, power tool, appliance or other similar device is removed from the personal power recharging organizer 20, it's power jack 74 can be wedged into one of the cable holding notches 68 found on the device railing 70 to prevent the cable 78 from slipping down into the housing 22.

In the non-powered embodiment of the personal power recharging organizer a manufactured power strip 80 would be mounted on to the housing back 34 either by using it's own mounting screws which could be screwed into some type of material 18 (like wood) or by screwing those same screws into already prepared and properly placed holes placed into the housing back 34.

As may now be understood, the device of the present invention provides an extremely adaptable organizer which may be utilized to store a wide variety of differently dimensioned cell phones, PDAs, power tools, appliances or other similar devices in a safe and organized manner.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the United States is as follows:

1. A cell phone, PDA, power tool, appliance or other similar device organizer comprising:
a housing including a substantially planar base and a plurality of receptacles each defining a mouth opening in said housing;
a plurality of electrical outlets mounted to said housing;
a main power switch connected to said electrical outlet for regulating the supply of electrical current to said outlet;
a main power cord connected to said power switch for supplying electrical current from a wall outlet; and
wherein the device receptacles in said housing are adjustable to receive cell phones, PDAs, power tools, appliances or other similar devices. These receptacles could also be constructed to have static, non-moveable walls.

2. The cell phone, PDA, power tool, appliance or other similar device organizer according to claim 1, further comprising a plurality of adjustable clamps that could hold cell phones, PDAs, power tools, appliances or other similar devices by squeezing the cell phones, PDAs, power tools, appliances or other similar devices between these clamps thus holding the cell phones, PDAs, power tools, appliances or other similar devices in place while they are being charged.

3. The cell phone, PDA, power tool, appliance or other similar device organizer according to claim 1, further comprising a non-skid surface that would not require clamps or receptacles to hold cell phones, PDAs, power tools, appliances or other similar devices. The cell phones, PDAs, power tools, appliances or other similar devices would simply lie on this non-skid surface while they are being charged.

4. The cell phone, PDA, power tool, appliance or other similar device organizer according to claim 1, further comprising a plurality of cable organizers used to hold the excess cable from the cell phone's, PDA's, power tools, appliances or other similar device's plug-in power adapters

5. The cell phone, PDA, power tool, appliance or other similar device according to claim 1, further comprising a plurality of cable holding notches used to hold the power jacks on the cell phone's, PDA's, power tool's, appliance's or other similar device's plug-in power adapters.

6. The cell phone, PDA, power tool, appliance or other similar device organizer according to claim 1, further comprising a plurality of cut-outs, slots and holes used to route the cell phone's, PDA's, power tool's, appliance's or other similar device's cables to keep them partially hidden and out of the way.

7. The cell phone, PDA, power tool, appliance or other similar device organizer according to claim 1, could also not have a lighted power Off/On switch. It may have only a main power cord which would cause the organizer's power to be on as soon as the power cord was plugged into an A/C receptacle.

8. The cell phone, PDA, power tool, appliance or other similar device organizer according to claim 1, could also be a non-powered version which would not have built in electrical receptacles but instead could use other manufacturers power strips to provide power to the cell phone's, PDA's, power tool's, appliance's or other similar device's plug-in power adapters.
